(19) United States
(12) Patent Application Publication
(10) Pub. No.: US 2022/0055568 A1
(43) Pub. Date: Feb. 24, 2022

(54) AIRBAG ASSEMBLY

(71) Applicant: Honda Motor Co., Ltd., Tokyo (JP)

(72) Inventors: Jimmie A. Ruffner, II, Marysville, OH (US); Andrew J. Ebert, Columbus, OH (US)

(21) Appl. No.: 16/996,041

(22) Filed: Aug. 18, 2020

(51) Int. Cl. B60R 21/2338

(52) U.S. Cl. CPC B60R 21/2338; B60R 21/206; B60R 2021/23382

(57) ABSTRACT

An airbag assembly for a vehicle and a method for assembling an airbag assembly includes an airbag cushion defining an inflatable chamber. The airbag cushion includes a front side facing a passenger compartment of the vehicle and a rear side positioned opposite the front side to face away from the passenger compartment. The airbag cushion further includes lateral end portions flanking a central portion with at least one of the lateral end portions being an enlarged end portion that is enlarged relative to the central portion. The airbag assembly further includes at least one primary tether disposed within the inflatable chamber and at least one secondary tether or tether portion disposed within the inflatable chamber for establishing the enlarged portion. The at least one primary tether extends longitudinally between the lateral end portions of the airbag cushion with longitudinal sides thereof attached, respectively, to the front and rear sides of the airbag cushion in the central portion of the airbag cushion.

### BACKGROUND

Vehicles generally provide some kind of supplemental restraint system. Often, these supplemental restraint systems take the form of inflatable devices or restraints. In some cases, an inflatable restraint system includes a leg protection device having an airbag deployed in front of the vehicle occupant to receive or engage the legs of the occupant in the event of a vehicle collision so as to protect the vehicle occupant. In some situations, the vehicle occupant may be moved laterally during a crash event, such as toward a side door or a center console, in addition to forward.

### BRIEF DESCRIPTION

An airbag assembly for a vehicle includes an airbag cushion defining an inflatable chamber. The airbag cushion includes a front side facing a passenger compartment of the vehicle and a rear side positioned opposite the front side to face away from the passenger compartment. The airbag cushion further includes lateral end portions flanking a central portion with at least one of the lateral end portions being an enlarged end portion that is enlarged relative to the central portion. The airbag assembly further includes at least one primary tether disposed within the inflatable chamber and at least one secondary tether or tether portion disposed within the inflatable chamber for establishing the enlarged portion. The at least one primary tether extends longitudinally between the lateral end portions of the airbag cushion with longitudinal sides thereof attached, respectively, to the front and rear sides of the airbag cushion in the central portion of the airbag cushion.

According to another aspect, a vehicle airbag assembly includes a first panel for facing a passenger compartment and a second panel for facing away from the passenger compartment. The first and second panels each have peripheral edges secured to one another to form a seam and thereby define an inflatable chamber. The vehicle airbag assembly also includes at least one primary tether disposed within the inflatable chamber. The at least one primary tether has longitudinal sides attached, respectively, to the first and second panels and at least one longitudinal end spaced apart from the seam between the first and second panels. The vehicle airbag assembly further includes at least one secondary tether or tether portion disposed within the inflatable chamber having at least one longitudinal end attached to the seam to establish an enlarged lateral end portion.

According to a further aspect, a method for assembling an airbag assembly includes attaching a front side or panel that is to face a passenger compartment in the vehicle to a rear side or panel to form an airbag cushion defining an inflatable chamber. The airbag cushion has lateral end portions flanking a central portion with at least one of the lateral end portions being an enlarged end portion that is enlarged relative to the central portion. The method further includes attaching longitudinal sides of at least one primary tether disposed within the inflatable chamber to, respectively, the front and rear sides of the airbag cushion in the central portion of the airbag cushion and disposing at least one secondary tether or tether portion within the inflatable chamber for establishing the enlarged portion.

### BRIEF DESCRIPTION OF THE DRAWINGS

FIG. 1 is a schematic illustration of a vehicle and a vehicle passenger compartment having an knee airbag assembly shown in a non-deployed state.

FIG. 2 is a schematic illustration similar to FIG. 1 but showing the knee airbag assembly in a deployed state wherein an airbag cushion is deployed near a vehicle occupant's knees.

FIG. 3 is a schematic view of a known knee airbag assembly shown in a non-deployed state.

FIG. 4 is another schematic view of another known knee airbag assembly shown in a deployed state and having an enlarged lateral end portion.

FIG. 5 is a schematic top view of a knee airbag assembly according to an exemplary embodiment.

FIG. 6 is a perspective view of the knee airbag assembly of FIG. 5.

FIG. 7 is a schematic top view of a knee airbag assembly according to another exemplary embodiment.

FIG. 8 is a perspective view of the knee airbag assembly of FIG. 7.

FIGS. 9A and 9B are schematic illustrations of a primary tether for the knee airbag assembly of FIGS. 7 and 8.

FIGS. 10A and 10B are schematic views of a primary tether according to an alternate embodiment for use in the knee airbag assembly of FIGS. 7 and 8.

FIG. 11 is a plan view of a primary tether according to another alternate exemplary embodiment for use in the knee airbag assembly of FIGS. 7 and 8.

FIG. 12 is a perspective view of a knee airbag assembly having the primary tether of FIG. 11 disposed therein and shown in a deployed state according to a further alternate exemplary embodiment.

FIG. 13 is a schematic plan view of a knee airbag assembly shown in FIG. 12.

FIG. 14 is a schematic plan view similar to FIG. 13 but showing yet a further alternate exemplary embodiment.

### DETAILED DESCRIPTION

It should, of course, be understood that the description and drawings herein are merely illustrative and that various modifications and changes can be made in the structures disclosed without departing from the present disclosure. As used herein, lateral directions are transverse across the vehicles, i.e., left and right, with directions. Likewise, longitudinal directions refer to forward and rearward directions of vehicle travel, and the vertical directions relate to elevation, i.e., upward and downward, height directions.

The present subject matter includes all operable combinations of features and aspects described herein. Thus, for example if one feature is described in association with an embodiment and another feature is described in association with another embodiment, it will be understood that the present subject matter includes embodiments having a combination of these features.

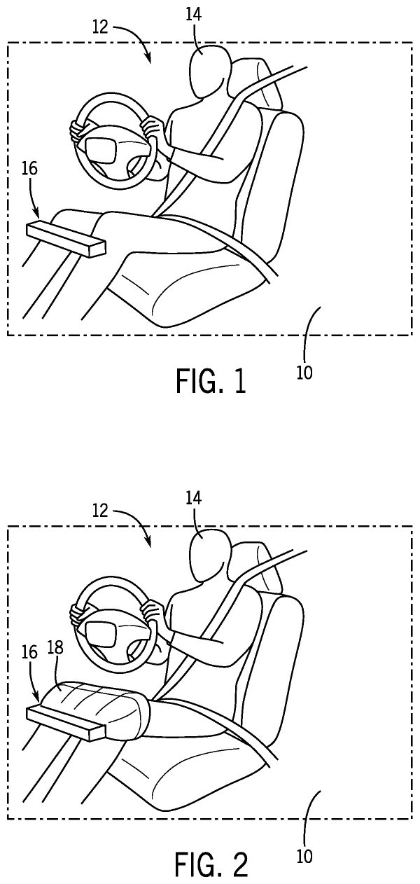

Referring now to the drawings, wherein like numerals refer to like parts throughout the several views, FIG. 1 schematically illustrates a vehicle 10 having a vehicle passenger compartment 12 in which an occupant 14 is seated. In FIGS. 1 and 2, the occupant 14 is shown as a driver, but it is to be appreciated that the occupant 14 could also be a passenger.

Within the passenger compartment 12, the vehicle 10 can have an airbag assembly 16, such as the schematically illustrated knee airbag assembly 16 of FIGS. 1 and 2. As is known and understood by those skilled in the art, the knee airbag assembly 16 can be configured to deploy from a stowed position or state (shown in FIG. 1) to a deployed position or state (shown in FIG. 2) during a load event in which the vehicle 10 is subjected to a load, for example a collision involving the vehicle 10. During some load events, the occupant 14 can be moved forward in the vehicle 10 and/or the vehicle 10 (e.g., the dashboard, not shown) or other component can be moved rearward toward the occupant 14. In addition, the occupant 14 can be moved laterally (e.g., toward a vehicle door or a center console area, both not shown) and/or these can be moved laterally toward the occupant 14. If a sufficient load is applied to the vehicle 10, as is known and understood by those skilled in the art, the knee airbag assembly 16 can deploy, as shown in FIG. 2. In the deployed state, an airbag cushion 18 can be inflated in the area of the legs or knees of the vehicle occupant 14 for purposes of cushioning any impact between the occupant 14 and the vehicle 10. In FIG. 2, the airbag cushion 18 has a generally uniform cross section or shape across a lateral dimension thereof.

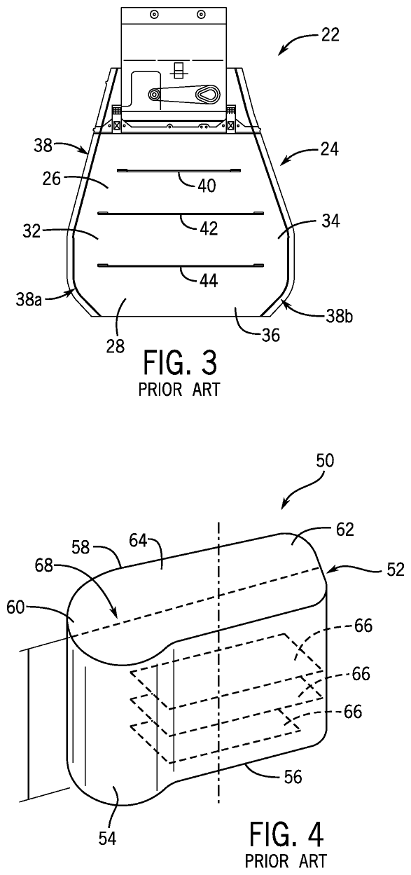

FIG. 3 shows a known knee airbag assembly 22, according to another embodiment, that could be used in place of the knee airbag assembly 16 of FIGS. 1 and 2. The knee airbag assembly 22 includes an airbag cushion 24 defining an inflatable chamber 26. The airbag cushion 24 includes a front side or panel 28 for facing the passenger compartment 12 of the vehicle 10 and a rear side or panel (not shown) positioned opposite the front side 28 for facing away from the passenger compartment 12. The airbag cushion 24 further includes lateral end portions 32, 34 flanking a central portion 36. The front panel 28 and the rear panel are secured to one another to form a seam 38 including a seam portion 38a disposed along the lateral end portion 32 and a seam portion 38b disposed along the lateral end portion 34.

The knee airbag assembly 22 further includes at least one tether (see tethers 40, 42, 44 in FIG. 3) disposed within the inflatable chamber 26. As shown, each of the tethers 40, 42, 44 has an equal amount of space disposed between ends thereof and the respective seam portions 38a, 38b. More particularly, the same spacing between the ends of the tethers 40, 42, 44 and the seam 38 is provided for each tether 40, 42, 44. As a result, when the airbag cushion 24 of FIG. 3 is deployed, the lateral end portions 32, 34 are not enlarged relative to the central portion 36 of the airbag cushion 24.

FIG. 4 illustrates another known knee airbag assembly 50, shown in a deployed state. The airbag assembly 50 includes an airbag cushion 52 defining an inflatable chamber 54. Like the knee airbag assembly 22, the airbag cushion 52 of the airbag assembly 50 includes a front side or panel 56 for facing the passenger compartment 12 of the vehicle 10 and a rear side or panel 58 positioned opposite the front side 56 for facing away from the passenger compartment 12. The airbag cushion 52 includes lateral end portions 60, 62 flanking a central portion 64 with the lateral end portion 60 being enlarged relative to the lateral end portion 62 and relative to the central portion 64. Such enlargement is obtained via a plurality of tethers 66. Each of the tethers 66 is disposed within the inflatable chamber 54 so as to be closer to the lateral end portion 62 than the lateral end portion 60, which is the enlarged lateral end portion. More particularly, a spacing from longitudinal ends of each of the tethers 66 relative to a seam 68 is smaller at the lateral end portion 62 than adjacent to the lateral end portion 60. In one embodiment, the tethers 66 are spaced equally away from the lateral end portion 62.

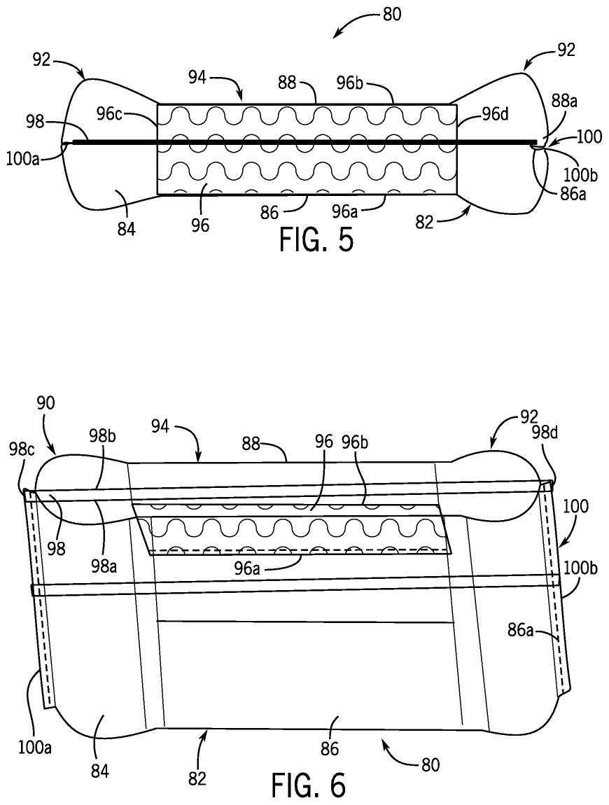

With reference now to FIGS. 5 and 6, an airbag assembly 80 is shown according to an exemplary embodiment that can be deployed in the vehicle 10. In particular, the airbag assembly 80 can be used in place of the airbag assembly 16 discussed hereinabove in reference to FIGS. 1 and 2. According to an exemplary embodiment, the airbag assembly 80 includes an airbag cushion 82 defining an inflatable chamber 84. The airbag cushion 82 includes a front side 86 for facing the passenger compartment 12 of the vehicle 10 and a rear side 88 positioned opposite the front side 86 to face away from the passenger compartment 12. The airbag cushion 82 further includes lateral end portions 90, 92 flanking a central portion 94 with at least one of the lateral end portions (i.e., both lateral end portions 90, 92 in the embodiment of FIGS. 5 and 6) being an enlarged portion that is enlarged relative to the central portion 94.

The airbag assembly 80 further includes at least one primary tether (e.g., primary tether 96 in FIGS. 5 and 6) disposed within the inflatable chamber 84. The at least one primary tether 96 extends longitudinally between the lateral end portions 90, 92 of the airbag cushion 82 with longitudinal sides 96a, 96b thereof attached, respectively, to the front and rear sides 86, 88 of the airbag cushion 82 in the central portion 94 of the airbag cushion 82. In one embodiment, the longitudinal sides 96a, 96b of the primary tether 96 are attached to the front and rear sides 86, 88, respectively, via stitching (not shown). Additionally, the airbag assembly 80 of FIGS. 5 and 6 further includes at least one secondary tether or tether portion (secondary tether 98 in FIGS. 5 and 6) disposed within the inflatable chamber 84 for establishing both of the lateral end portions 90, 92 as an enlarged portion relative to the central portion 94.

In particular, in the embodiment illustrated in FIGS. 5 and 6, the at least one secondary tether or tether portion is at least one secondary tether, specifically the secondary tether 98, extending longitudinally between the lateral end portions 90, 92 of the airbag cushion 82 with longitudinal sides 98a, 98b (shown in FIG. 6) thereof unattached to the front and rear sides 86, 88 of the airbag cushion 82 in the central portion 94. Further, the at least one secondary tether, i.e., secondary tether 98, has longitudinal ends 98c, 98d (shown in FIG. 6) that are attached to the front and rear sides 86, 88 of the airbag cushion 82 at the lateral end portions 90, 92.

In one embodiment, the longitudinal sides 96a, 96b of the primary tether 96 are attached, respectively, to the front and rear sides 86, 88 of the airbag cushion 82 along an entire longitudinal extent of each of the longitudinal sides 96a, 96b. In the illustrated embodiment, the front side 86 is formed of or as a first panel and the rear side 88 is formed of or as a second panel. The first and second panels 86, 88 each have peripheral edges 86a, 88a, respectively, that are secured to one another to form a seam 100. The longitudinal ends 98c, 98d of the secondary tether 98 are attached to the front and rear sides 86, 88 of the airbag cushion 82 at the seam 100 at the lateral end portions 92, 94.

As shown in the embodiment of FIGS. 5 and 6, the primary tether 96 has longitudinal ends 96c, 96d that are spaced apart from the seam 100 at the lateral end portions 90, 92. In particular, in the illustrated embodiment, the longitudinal ends 96c, 96d of the primary tether 96 are spaced apart equally from the seam 100 at each of the lateral end portions 90, 92. More particularly, as shown, the seam 100 includes a first lateral seam portion 100a and a second lateral seam portion 100b. As shown, the primary tether 96, particularly the longitudinal ends 96c, 96d thereof, does not extend to at least one of the first seam portion 100a or the second seam portion 100b (and in the embodiment of FIGS. 5 and 6 does not extend to either seam portion 100a, 100b).

More particularly, in the embodiment of FIGS. 5 and 6, the primary tether 96 does not extend to either of the first seam portion 100a or the second seam portion 100b. As shown, the primary tether 96 extends only between the lateral end portions 90, 92 of the airbag cushion 82 and does not extend into the lateral end portions 90, 92. By this arrangement, the tethers 96, 98 together form the central portion 94 of the generally uniform thickness and form both of the lateral end portions 92, 94 as enlarged end portions due to the lack of the primary tether 96 being secured to the front and rear sides 86, 88 at the lateral end portions 92, 94 in combination with the secondary tether 98 not being attached to the front and rear sides 86, 88 within the central portion 94 but being attached at the seam 100, and particularly at each of the lateral seam portions 100a, 100b via the longitudinal ends 98c, 98d of the secondary tether 98.

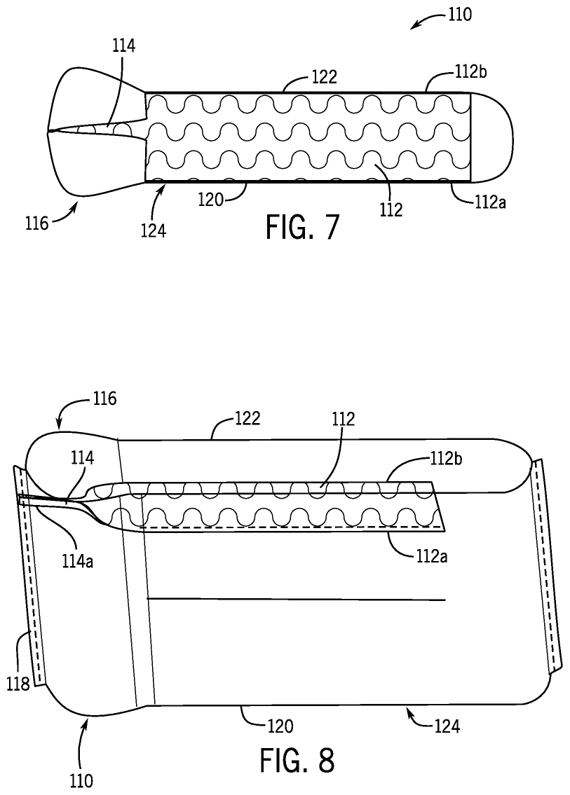

With reference now to FIGS. 7 and 8, an airbag assembly 110 is shown according to an alternate exemplary embodiment. Except as described hereinbelow, the airbag assembly 110 can be the same as the airbag assembly 80. However, the airbag assembly 110 uses a single tether in place of separate primary and secondary tethers to create an enlarged lateral end portion at one lateral end only. More specifically, the airbag assembly 110 can include at least one primary tether (for example, primary tether 112) disposed therein. Additionally, the airbag assembly 110 can include a secondary tether portion 114 instead of a separate secondary tether, such as the secondary tether 98 of the airbag assembly 80. More particularly, the secondary tether portion 114 of the airbag assembly 110 can be integrally and unitarily formed with the primary tether 112 to form enlarged lateral end portion 116 (shown as the left lateral end portion in FIGS. 7 and 8).

As shown, the secondary tether portion 114 has a distal end 114a (shown in FIG. 8) attached to first and second sides 120, 122 of an airbag cushion 124 of the airbag assembly 110 at a seam 118 formed by peripheral edges on the first and second sides 120, 122. As also shown, the secondary tether portion 114 is spaced apart from the first and second sides 120, 122 of the airbag cushion 124 within the enlarged portion 116 between the primary tether 112 and the seam 118. In all other respects, the primary tether 112 can be the same as the primary tether 96 of the airbag assembly 80. In particular, the primary tether 112 can have its longitudinal sides 112a, 112b attached to the front and rear sides 120, 122, respectively, of the airbag cushion 124, and optionally these can be attached (e.g., via stitching) along entire extents of the longitudinal sides 112a, 112b at least in as much as the sides 112a, 112b are disposed within the central portion 94.

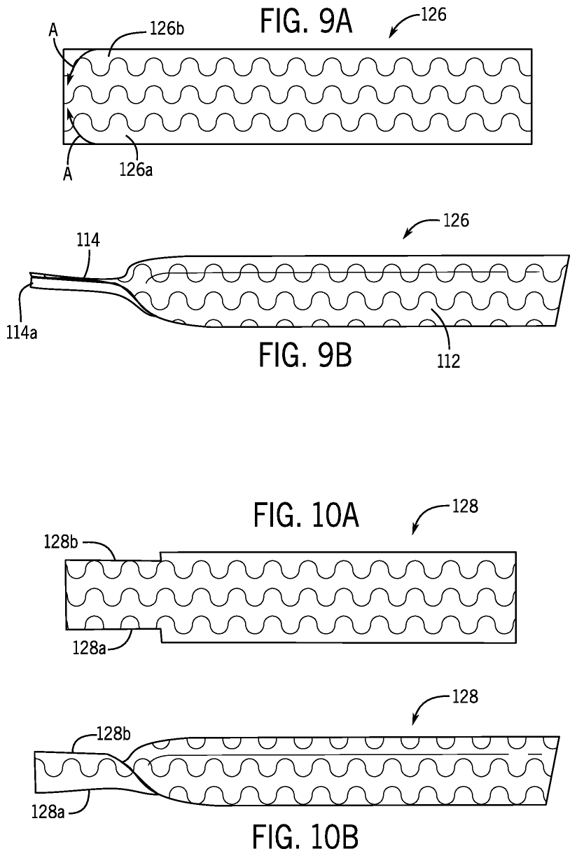

With reference to FIGS. 9A and 9B, the primary tether 112 and secondary tether portion 114 can be formed from a rectangular shaped tether material, i.e., rectangular tether strip 126. In particular, the secondary tether portion 114 can be formed by folding portions 126a, 126b as shown by arrows A. The folding portions 126a, 126b can be coupled together by any known means, such as, but not limited to, sewing, adhesive, clamps, etc. or any combination thereof. Such folding allows the secondary tether portion 114 to be spaced apart within the enlarged lateral end portion 116 from the first and second sides 120, 122, except that the distal end 114a can be secured to the first and second sides 120, 122 at the seam 118.

FIGS. 10A and 10B illustrate an alternative method for forming the primary tether 112 and the secondary tether 114. In particular, in FIGS. 10A and 10B, a rectangular tether strip 128 includes notched end portions 128a, 128b. To form the secondary tether portion 114, the notched end portions 128a, 128b are folded so as to be perpendicular relative to the remainder of the rectangular tether strip 128 and otherwise disposed or assembled in the airbag assembly 110 in the same manner as the rectangular tether strip 126. The folding portions 128a, 128b can be coupled together by any known means, such as, but not limited to, sewing, adhesive, and/or clamps.

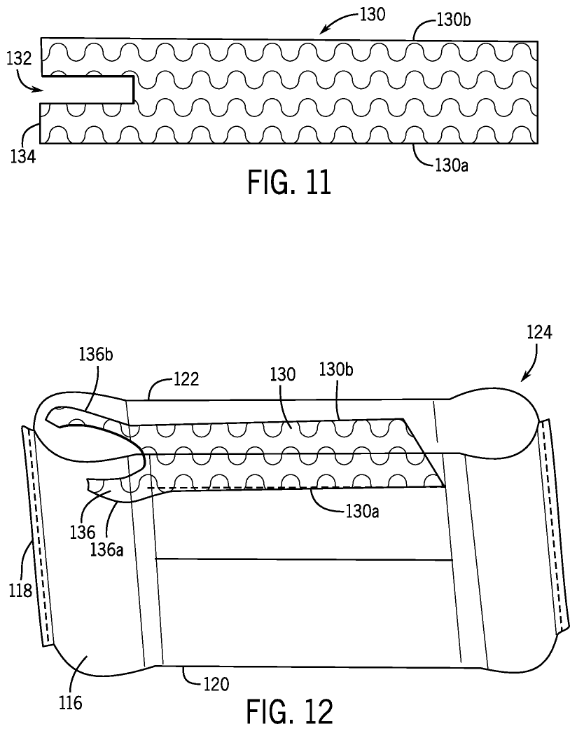

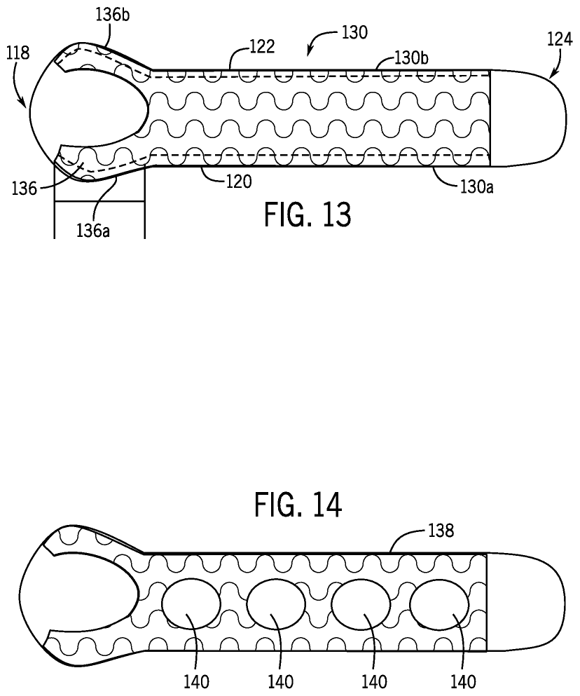

With reference to FIG. 11, yet another exemplary embodiment is shown. In particular, in FIG. 11, a rectangular tether strip 130 is shown and includes a notch 132 at one end 134 thereof. The rectangular tether 130 can be used as the second tether portion. As shown in FIGS. 12 and 13, the tether strip 130 can be used in a similar manner as the tether strips 126, 128. In particular, longitudinal sides 130a, 130b can be attached to the first and second sides 120, 122 of the airbag cushion 124 (see FIG. 13). The secondary tether portion 136 is integrally and unitarily formed with the primary tether 112; however, the secondary tether portion 136 in the embodiment of FIG. 12 is attached to the first and second sides 120, 122 in the enlarged lateral end portion 116. In particular, the secondary tether portion 136 has its longitudinal sides 136a, 136b thereof attached, respectively, to the front and rear sides 120, 122 of the airbag cushion 124 in the enlarged end portion 116. The notch or recess 132 faces toward the seam 118 between the front and rear sides 120, 122 of the airbag cushion 124. Alternatively, the notch 132 can be eliminated, and the folding portions 136a, 136b can be coupled together by any known means, such as, but not limited to, sewing, adhesive, clamps, etc. or any combination thereof.

With reference to FIG. 14, yet a further exemplary embodiment is illustrated. In the embodiment illustrated in FIG. 14, a strip 138 can be used as the primary tether and the secondary tether portion. In particular, the strip 138 can be the same as the strip 130 described hereinabove in reference to FIGS. 11-13 except that the strip 138 includes apertures 140 defined therein. In particular, the apertures 140 can be spaced apart from longitudinal sides of the strip 138.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. An airbag assembly for a vehicle, comprising:
an airbag cushion defining an inflatable chamber, the airbag cushion including a front side facing a passenger compartment of the vehicle and a rear side positioned opposite the front side to face away from the passenger compartment, the airbag cushion further including lateral end portions flanking a central portion with at least one of the lateral end portions being an enlarged end portion that is enlarged relative to the central portion;
at least one primary tether disposed within the inflatable chamber, the at least one primary tether extending longitudinally between the lateral end portions of the airbag cushion with longitudinal sides thereof attached, respectively, to the front and rear sides of the airbag cushion in the central portion of the airbag cushion; and
at least one secondary tether or tether portion disposed within the inflatable chamber for establishing said enlarged portion.

2. The airbag assembly of claim 1, wherein said at least one secondary tether or tether portion is at least one secondary tether extending longitudinally between the lateral end portions of the airbag cushion with longitudinal sides unattached to the front and rear sides of the airbag cushion in the central portion and the at least one secondary tether having longitudinal ends thereof attached to the front and rear sides of the airbag cushion in the lateral end portions.

3. The airbag assembly of claim 1, wherein the longitudinal sides of the at least one primary tether are attached, respectively, to the front and rear sides of the airbag cushion along an entire longitudinal extent of each of the longitudinal sides.

4. The airbag assembly of claim 1, wherein the front side is formed of a first panel and the rear side is formed of a second panel, the first and second panels each have peripheral edges secured to one another to form a seam, wherein the longitudinal ends of the at least one secondary tether are attached to the front and rear sides of the airbag cushion at the seam at the lateral end portions.

5. The airbag assembly of claim 4, wherein the at least one primary tether has longitudinal ends spaced apart from the seam at the lateral end portions.

6. The airbag assembly of claim 5, wherein the longitudinal ends of the at least one primary tether are spaced apart equally from the seam at each of the lateral end portions.

7. The airbag assembly of claim 4, wherein the seam includes a first lateral seam portion and a second lateral seam portion, wherein the at least one primary tether does not extend to at least one of the first lateral seam portion or the second lateral seam portion.

8. The airbag assembly of claim 7, wherein the at least one primary tether does not extend to either the first lateral seam portion or the second lateral seam portion.

9. The airbag assembly of claim 1, wherein the at least one primary tether extends only between the lateral end portions of the airbag cushion and does not extend into the lateral end portions.

10. The airbag assembly of claim 1, wherein said at least one secondary tether or tether portion is a secondary tether portion integrally and unitarily formed with said at least one primary tether to form the enlarged end portion, the secondary tether portion having a distal end attached to the first and second sides of the airbag cushion at a seam.

11. The airbag assembly of claim 10, wherein the secondary tether portion is spaced apart from the first and second sides of the airbag cushion within the enlarged portion between the at least one primary tether and the seam.

12. The airbag assembly of claim 1, wherein said at least one secondary tether or tether portion is a secondary tether portion integrally and unitarily formed with said at least one primary tether to form the enlarged end portion, the secondary tether portion disposed within one of the lateral end portions to form the enlarged end portion, the secondary tether portion having longitudinal sides thereof attached, respectively, to the front and rear sides of the airbag cushion in the enlarged end portion and defining a recess facing toward a seam between the front and the rear sides of the airbag cushion.

13. The airbag assembly of claim 1, wherein the at least one primary tether includes at least one aperture defined therein and said at least one aperture is spaced apart from said longitudinal sides of the at least one primary tether.

14. A vehicle airbag assembly, comprising:
a first panel for facing a passenger compartment;
a second panel for facing away from the passenger compartment, the first and second panels each having peripheral edges secured to one another to form a seam and thereby define an inflatable chamber;
at least one primary tether disposed within the inflatable chamber, the at least one primary tether having longitudinal sides attached, respectively, to the first and second panels and at least one longitudinal end spaced apart from the seam between the first and second panels; and
at least one secondary tether or tether portion disposed within the inflatable chamber having at least one longitudinal end attached to the seam to establish an enlarged lateral end portion.

15. The vehicle airbag assembly of claim 14, wherein the at least one primary tether includes both longitudinal ends spaced apart from the seam formed by the first and second panels.

16. The vehicle airbag assembly of claim 15, wherein the at least one secondary tether or tether portion is a secondary tether having both longitudinal ends attached to the seam to establish the enlarged lateral end portion as a first enlarged lateral end portion and to establish a second enlarged lateral end portion with a central portion disposed between the first and second lateral end portions.

17. The vehicle airbag assembly of claim 15, wherein the at least one secondary tether or tether portion is a secondary tether portion integrally and unitarily formed with said at least one primary tether to form the enlarged lateral end portion, the secondary tether portion having a distal end attached to the first and second panels at the seam.

18. The vehicle airbag assembly of claim 14, wherein the at least one secondary tether or tether portion is a secondary tether having both longitudinal ends attached to the seam to establish the enlarged lateral end portion as a first enlarged lateral end portion and to establish a second enlarged lateral end portion with a central portion disposed between the first and second lateral end portions.

19. The vehicle airbag assembly of claim 14, wherein said at least one secondary tether or tether portion is a secondary tether portion integrally and unitarily formed with said at least one primary tether to form the enlarged lateral end portion, the secondary tether portion having longitudinal sides thereof attached, respectively, to the front and rear panels in the enlarged end portion and defining a recess facing toward the seam between the front and the rear panels.

20. A method for assembling an airbag assembly, comprising:
attaching a front side or panel that is to face a passenger compartment in a vehicle to a rear side or panel to form an airbag cushion defining an inflatable chamber, the airbag cushion having lateral end portions flanking a central portion with at least one of the lateral end portions being an enlarged end portion that is enlarged relative to the central portion;
attaching longitudinal sides of at least one primary tether disposed within the inflatable chamber to, respectively, the front and rear sides of the airbag cushion in the central portion of the airbag cushion; and
disposing at least one secondary tether or tether portion within the inflatable chamber for establishing said enlarged portion.
